(19) United States
(12) Patent Application Publication
(10) Pub. No.: US 2003/0009740 A1
(43) Pub. Date: Jan. 9, 2003

(54) Dual & parallel software development model

(75) Inventor: Hongbing Lan, Beijing (CN)

Correspondence Address: Albert Wai-Kit Chan or Mark Elkins, 59-42 Parsons Blvd., Flushing, NY, 11365-1433, US

(73) Assignee: ESOFTBANK (BEIJING) SOFTWARE SYSTEMS CO., LTD., Beijing (CN)

(21) Appl. No.: 09/878,492

(22) Filed: Jun. 11, 2001

(51) Int. Cl. G06F 9/44

(52) U.S. Cl. 717/102; 717/103

(57) ABSTRACT

The invention disclosed herein provides a system comprising at least one collaborative component to eliminate communication barriers between software clients and developers and at least one development component for accelerating software development and enhancing quality assurance. The invention also provides an online software development system comprising three collaborative components to eliminate communication barriers between software clients and developers and three development components for accelerating software development and enhancing quality assurance. Furthermore, this invention provides the above system wherein the three collaborative components comprise: (1) a Quality Assurance Project Manager; (2) Collaboration Management & Project Management; and (3) a Prototype Server. In addition, the invention provides the above system wherein the three development components comprise: (1) a Development Project Manager; (2) CASE Management & Knowledge Management; and (3) a Development Server. Finally, this invention provides the above system wherein the online software development environment seamlessly connects vendors and buyers of software in terms of dual project managers using dual management tools and dual servers in dual platforms.

### BACKGROUND OF THE INVENTION

This invention helps ensure the success of every Information Technology (IT) initiative in an outsource marketplace by connecting buyers of IT services (clients) with the highest quality software development solution providers (vendors). In order to reach this target, the invention includes a unique model called “Dual & Parallel Software Development Model” to greatly improve the communication gap between clients and vendors and to effectively control all details of assigned projects. Dual & Parallel Software Development Model enables companies to get quality software developed on time and on budget.

### SUMMARY OF THE INVENTION

The invention disclosed herein provides a system comprising at least one collaborative component to eliminate communication barriers between software clients and developers and at least one development component for accelerating software development and enhancing quality assurance.

The invention also provides an online software development system comprising three collaborative components to eliminate communication barriers between software clients and developers and three development components for accelerating software development and enhancing quality assurance.

In an embodiment, this invention provides three collaborative components to eliminate communication barriers between software clients and developers. In another embodiment, the invention provides three interactive development components for accelerating software development and enhancing quality assurance. In yet another embodiment, this invention provides the above system wherein the collaborative components and the development components work in a parallel fashion to smooth the entire software development process.

In addition, the invention provides the above system wherein the three collaborative components comprise: (1) a Quality Assurance Project Manager; (2) Collaboration Management & Project Management; and (3) a Prototype Server. In an embodiment, communication occurs via the Internet.

The invention further provides the above system wherein the three development components comprise: (1) a Development Project Manager; (2) CASE Management & Knowledge Management; and (3) a Development Server.

Finally, this invention provides the above system wherein the online software development environment seamlessly connects vendors and buyers of software in terms of dual project managers using dual management tools and dual servers in dual platforms.

### DETAILED DESCRIPTION OF THE FIGURES

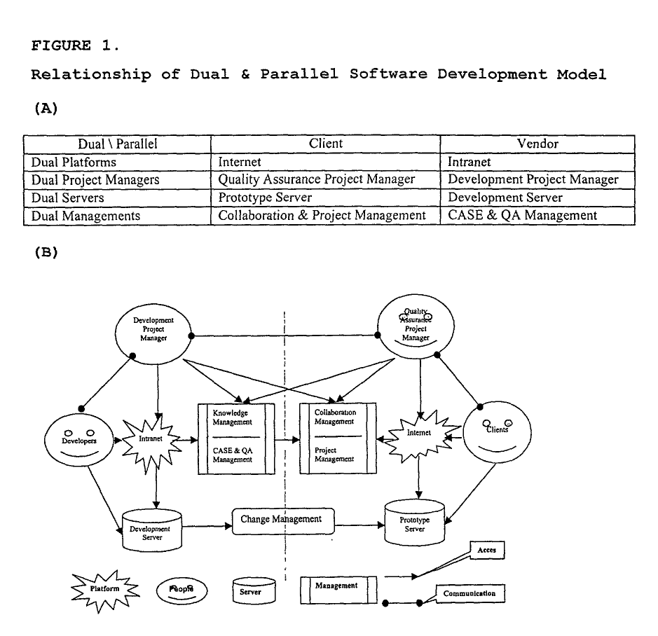

FIG. 1 (A) and (B).

Dual & Parallel Software Development Model

These figures illustrate the general architecture that includes dual platforms, dual project managers, dual managements, and dual servers. They also show the seamless relationship between clients and developers by virtue of three-way interactive communication.

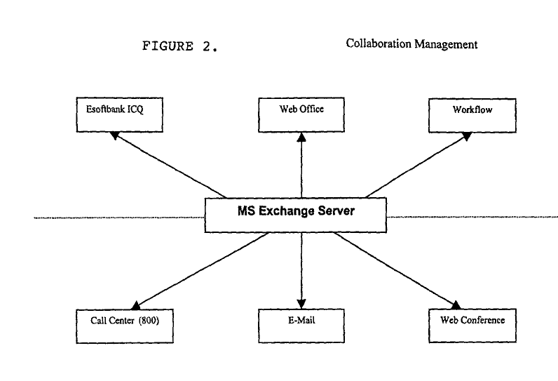

FIG. 2.

Collaboration Management

This figure illustrates multiple channels of collaboration management that includes internal methods among developers and external methods between clients and developers via Microsoft Exchange Server.

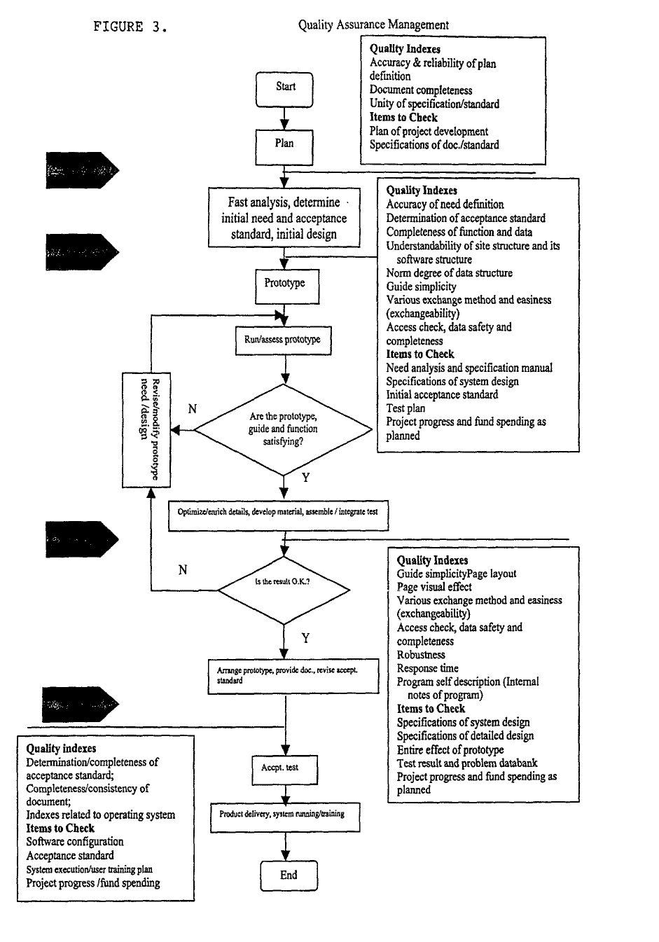

FIG. 3.

Quality Assurance Management

This figure illustrates the flow chart of Quality Assurance Management and checkpoints that setup conditions and certain items must pass.

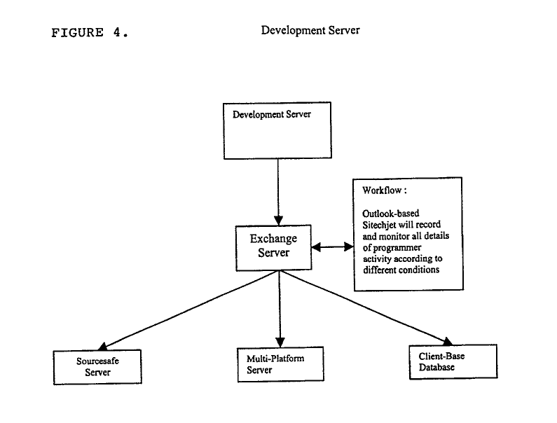

FIG. 4.

Development Server

This figure illustrates the complete software development environment.

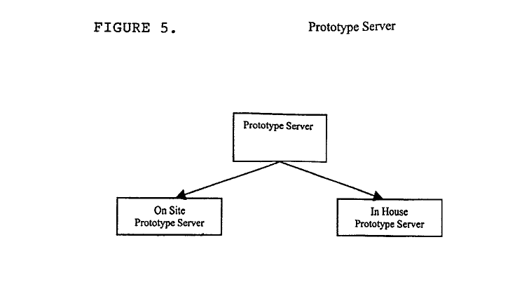

FIG. 5.

Prototype Server

This figure illustrates the location of the prototype server accessed by clients.

### DETAILED DESCRIPTION OF THE INVENTION

The present invention provides a system comprising at least one collaborative component to eliminate communication barriers between software clients and developers and at least one development component for accelerating software development and enhancing quality assurance.

The invention also provides an online software development system comprising three collaborative components to eliminate communication barriers between software clients and developers and three development components for accelerating software development and enhancing quality assurance.

In an embodiment, this invention provides three collaborative components to eliminate communication barriers between software clients and developers. In another embodiment, the invention provides three interactive development components for accelerating software development and enhancing quality assurance. In yet another embodiment, this invention provides the above system wherein the collaborative components and the development components work in a parallel fashion to smooth the entire software development process.

In addition, the invention provides the above system wherein the three collaborative components comprise: (1) a Quality Assurance Project Manager; (2) Collaboration Management & Project Management; and (3) a Prototype Server. In an embodiment, communication occurs via the Internet. In another embodiment, component (1), the Quality Assurance Project Manager, is responsible for four checkpoints. In yet another embodiment, the first checkpoint comprises checking the quality indexes of accuracy and reliability of plan definition, document completeness, and unity of specification/standard; and the items of plan of project development and specifications of doc./standard. In still another embodiment, the second checkpoint comprises checking the quality indexes of accuracy of need definition, determination of acceptance standard, completeness of function and data, understandability of site structure and its software structure, norm degree of data structure, guide simplicity, various exchange methods and easiness (exchangeability), and access check, data safety and completeness; and items of need analysis and specification manual, specification of system design, initial acceptance standard, test plan, and project progress and fund spending as planned.

In a further embodiment, the third checkpoint comprises checking the quality indexes of guide simplicity/page layout, page visual effect, various exchange method and easiness (exchangeability), access check, data safety and completeness, robustness, response time, program self description (internal notes of program); and the items of specifications of system design, specifications of detailed design, entire effect of prototype, test result and problem databank, and project progress and fund spending as planned. In yet another embodiment, the fourth checkpoint comprises checking the quality indexes of determination/completedness of acceptance standard, completeness/consistency of document, indexes related to operating system; and the items of software configuration, acceptance standard, system execution/user training plan, and project progress/fund spending.

This invention also provides the above system wherein component (2) (Collaboration Management) comprises multiple management channels, including internal methods among developers (such as a collaborative tool, an intranet-based communication tool and a workflow tool), and external methods between clients and developers (such as a toll-free call center, e-mail, and web conferencing) via a collaboration platform. Furthermore, the invention provides the above system wherein component (2) (Project Management) comprises Development Plan Management; Resource Management (including human resource, code, documents, solutions, etc.); Expense Management; Development Trace and Control; Configuration Management; Bug Report; Task Management; and Project Member Management.

The invention also provides the above system wherein component (3) (Prototype Server) comprises an on-site prototype server and an in-house prototype server.

The invention further provides the above system wherein the three development components comprise: (1) a Development Project Manager; (2) CASE Management & Knowledge Management; and (3) a Development Server. In an embodiment, software developers communicate with each other via an intranet. In another embodiment, component (1), the Development Project Manager, is responsible for leading the development team to make the development plan; submitting stage development results and finishing the whole development of the project (including testing); coordinating with the QA team and clients to revise the development result in order to meet clients' requirements; and assuring software quality required by the QA team. In still another embodiment, component (2), Computer-Aided Software Engineering (CASE) Management, comprises all activities of the whole software survival period, including personnel organizing and managing, plan management, standardized management, software configuring management, software quality assurance management, spending management, project-tracing, and process controlling management.

In yet another embodiment, component (2), Knowledge Management, is the core technical support and knowledge-sharing platform. In a further embodiment, component (3), the Development Server, comprises a Collaborative Platform in which Workflow is the tool used to record and monitor all detailed activities of programmers according to different conditions.

This invention further provides the above system wherein the Collaborative Platform comprises a Configuration Management Server, a Multi-Platform Server, and a Client-Based Database. The invention also provides the above system wherein the online software development environment seamlessly connects vendors and buyers of software in terms of dual project managers using dual management tools and dual servers in dual platforms.

Furthermore, this invention provides the above system wherein the dual project managers comprise the Development Project Manager and the Quality Assurance Project Manager. In an embodiment, the dual managements comprise: Knowledge Management and Computer-Aided Software Engineering (CASE) & Quality Assurance (QA) Management. In an embodiment, Knowledge Management gives software users access to a full range of services, including, but not limited to, information management, project management, resource center, user management, system maintenance, and technical communication. This invention also provides a method wherein an interface allows third-party software plug in and integrate so as to fully utilize all functions. The invention still further provides a method wherein Quality Assurance (QA) Management is handled by the Quality Assurance Manager.

In addition, this invention provides a method wherein the dual servers comprise Development Server and Prototype Server, which work concurrently. In an embodiment, Development Server is used by the project's software programmers and Prototype Server is used by software clients. In another embodiment, the two servers are independent and linked by Change Management. In an embodiment, Change Management is delivered through an integrated, project-oriented incident management system.

The invention also provides a method wherein each workstation includes its own integrated defect tracking system which links defects to particular pieces of the software code.

Finally, this invention provides a method wherein the dual platforms comprise an intranet used by software programmers to access data internally and the Internet used by software clients to access their information.

This invention provides an online collaboration system which includes dual platforms, dual servers, dual project managers, and dual managements, as defined below.

Dual Platforms

Based on visual development environment, two platforms are provided; programmers use intranet to access data internally while clients use the Internet to access their information.

Dual Servers

Two servers are independent and are linked by change management; development server is used by project programmers and prototype server is used by clients to make sure program is exactly what they required.

Dual Project Managers

Two project managers are independently responsible for the same project and keep good outsourcing highest quality as well as good relationships with clients; one manager supervises development and the other supervises quality assurance.

Dual Managements

Two sets of management tools are employed to communicate, control, monitor, and ensure the project progress to satisfy clients' specific criteria and technical requirements. From the viewpoint of clients, it provides exceptional online collaboration and project management tools and expertly manages collaborative interaction throughout the project development lifecycle. This gives development teams sufficient resources and skills to finish their projects in terms of knowledge management and CASE & QA management.

Clients normally communicate “face to face” with project managers directly or through the phone. Online collaboration tools, such as the one disclosed in this invention, allow clients to work in real-time with vendors, whether they are across the street or across the globe. The collaboration platform is a core of communication in this invention. The collaborative tools integrate with development tools such as Microsoft Visual Basic (VB) & Visual C++ (VC) so that it is easy for programmers to communicate in real time. The invention utilizes Web Office, a shared collaborative environment to provide a virtual developer community which is able to exchange any information and topic, and it accumulates their developer knowledge easily. In this invention, Workflow is the tool used to record and monitor all details of programmer activity during the development lifecycle. Clients can make calls to or e-mail the project manager or even use real-time web conferencing to discuss issues with the project manager.

Project Management

Projects are classified as Formal Projects or Simple Projects.

Formal Project: It is to be developed according to the normal engineering process, executed completely in accordance with the thinking of software engineering and the formal specifications of project development. This category includes the most-common software development projects.

The formal projects are further classified into in-house projects and external projects (those assigned by external clients). These differ in the procedure for project pre-approval and the production of a feasibility study. External projects involve a development plan and need provisions for software release.

The following flow charts describe the processes.

In-House Formal Project Developed by Internal Development Team

Project application→(feasibility study)→Pre-approval and assignment of task→Project planning→Need analysis→Test of analysis stage→Summary design→Detail design→Test in design stage→Project development under the project control (Programming→Unit test)→Project test→Installation, Set-up, Acceptance and Delivery→Project summary.

External Formal Project Development Process

Project negotiation→Project planning→(Tendering)→Application for project pre-approval→Pre-approval of project and task assigned→Project planning→Need analysis→Test of analysis stage→Summary design→Detailed design→Test of design stage→Project development under the project control (Programming→unit test)→Project test→Installation, test-up, acceptance and delivery→Project summary.

Simple Project: The scale of these projects is very small. They tend to be without significant technical difficulties.

A simple project requires simple pre-approval of the simple project process and development. The following flow chart describes this process and development.

Negotiation→Programs→(tendering)→Application→Pre-approval of project and assignment of tasks>Plan→Analysis and design→Stage evaluation & test→Project development under the project control (Programming—unit test)→Project test→Installation, Setup, Acceptance and Delivery→Project Summary.

At the time when the application for project approval is submitted, the nature of the project should be determined. The project nature cannot be changed during the project development. A new application must be submitted for approval if the project scale is to be changed.

Knowledge Management

This is the core technical support and knowledge-sharing platform of the invention. It enhances technical skills and competitive advantage, and facilitates efficient inter-departmental collaboration. The implementation of knowledge management is fundamental to this invention's web-based software development paradigm. Through this platform, users have access to a full range of services.

Management should include different sections such as information management, project management, resource center, user management, system maintenance, and technical communication, etc. Knowledge management also offers an interface to allow third-party software plug in and integrates so as to fully utilize all functions.

Computer Aided Software Engineering Management (CASE Management)

Management includes all activities of the whole software survival period. It is the key to a successful project. Its tasks are managing personnel effectively, employing advanced technology and tools, finishing scheduled software projects according to the schedule, and assuring the quality of software products.

Managers' functions include making plans, establishing organizations, quantifying tasks, employing personnel, guiding the whole process, inspecting, controlling and checking.

The management work which should be done during the development process is as follows:

1) Personnel Organizing and Managing

Generally the development organizing structure has these forms:

Mode according to the problems

Mode according to the functions

Mode according to the matrix shape

Procedure design and development are organized in the following forms of procedure groups.

Main programmer group

Democratic group

Levels group

2) Plan Management

Project development plan

Quality assurance plan

Software testing plan

Document workout plan

Setting/training plan

3) Standardized Management

Development process standard

Document standard

4) Software Configuring Management

Configuration item change control and recording

Document's trace and controlled access

Constant check of software configuration

5) Software Quality Assurance Management

6) Spending Management

7) Project-Tracing And Process Controlling Management

Quality Assurance Management (QA Management) (See FIG. 3)

Process of Quality Assurance

Quality control of the project should be done throughout the whole process of development. This thorough attention to quality assurance throughout the duration of the project guarantees the quality of the final product. The following are the steps for quality assurance:

1) Determine the quality requirements and describe with a hierarchical tree diagram (three levels required).

2) In line with the quality requirements, take the assessment norms for the results assessable and the measure index of each norm to establish an expansion table of quality characteristics (requirement features—assessment norm—measure indexes). This is a model of quality measures.

3) Establish a matrix relation between the quality requirements and quality characteristics in order to determine the weighted relation between the third-level requirements and measure indexes.

4) Establish a hierarchical expansion table of the software functions, using a hierarchical structure (function level—sub-function level—detailed function level). Form a weighted matrix table between the function and index of quality measure, assigning a quality index to each function to establish a quality assessment standard for each function part.

5) Establish a structure expansion table of sub-systems (modules). Form a relational matrix of the function corresponding to the module (the object-oriented system should be the organizational structure of the sub-system group), so that the index of the quality measure will be allocated to the modules to be developed. This will form a corresponding relational matrix of the modules—measure indexes (or relational matrix of group—measure index).

6) Establish a quantity assessment table for the index of each quality measure, which is used to give quantified scores when evaluating the software quality.

7) Define the quality assurance organization and control process, determine quality checkpoints and the items for quality check, allocate the measure indexes to corresponding items so as to assess the quality during the project development.

8) Conduct quality assessment of the checkpoints, provide a score table, establish an analysis quality graph of the actual deviation from the object, and improve part of the problem existing in the location quality.

9) Confirm the software quality level:

a) All the products and projects of the company should be tested before use and distribution.

b) Based on the client company's situation, a general quality certification standard is the result of the “usage test.” This is the description of the project and items according to the requirements, the test results of all the functions. This includes the test results obtained under the likely target platform.

c) The project manager prepares the test work according to the requirement description. The testing staff should conduct the test work according to the test process and method, and record the test results. Other team members of the project should record the revised items and all the test records should be properly maintained.

d) The project manager should submit a report on the test results, including the test results of all the functions and the name list of the test staff.

e) The project manager should submit a summary report on the test work, including the type of errors, the number of errors and main causes of the errors.

Development Server (See FIG. 4)

1. Programmer logs on to collaborative platform which will check his/her authority according to the workflow management tool.

2. After approved by a workflow management tool, the programmer can go to the configuration management server to develop program.

3. Multi-platform Servers which include different platforms such as Sun, IBM, Unix/Linux, Wintel and so on, provide a real environment to let programmers run and test their program after they finish their coding.

4. Client base database server can be prototype server in house or mirror to prototype server on client site so as to provide programmers easy access.

Prototype Server (See FIG. 5)

Prototype Server can host on client site or in house depending on the client requirements and actual situations.

Client can access prototype server via LAN or the Internet.

There is a Change Management to control their up-to-date program between development server and prototype server.

Electronic security and encryption will apply to all processes and will provide a very secure environment.

Change Management

This invention delivers better change than regular change management thorough an integrated project-oriented incident management system. Software defects and bugs have a direct impact on source code revisions. That is why each workstation includes its own integrated defect tracking system. Workstation handles defect tracking seamlessly within the context of a project by linking defects to particular pieces of the code.

Store, filter and group change requests by any attribute including status, responsibility or severity.

Create relationships across objects in the repository with system generalized linking engine.

Our workflow model provides complete Process Management of incidents through their life cycle.

Customize the interface to track just the information important to your project.

Generate reports and charts to access and distribute project status.

Authorized version release will implement over the Internet/intranet through the invention's Dual Servers.

Comparison of This Invention and Its Counterparts

Characteristics of This Invention

If regarded as a single tool, this invention has none of its apparent advantages. Although the functions of desktop tools in the current market are very abundant, different function blocks are separate and cannot show the close relationships between each kernel process. Only the web-based tools, which provide a highly integrated environment, cover the kernel process of CMM, are this invention's competitors. This invention is a platform with overall advantages. This platform can provide clients with tools and resource support, so in this platform, a highly integrated tools set and resource base are included. This platform provides tools support, resource management and intelligent query and pushing of resources in desktop or ASP ways.

The characteristics of this invention are as follows:

This invention is a highly integrated development management and control platform. It combines development process, quality assurance process, configuration management process, bug report and feedback, collaborative communication and other support process needed. This invention supports the close relationships between these processes with the help of corresponding tools. So the tools in this platform are not separate, but related to each other very closely.

Dual Managers and Dual Processes Mechanism. Supporting QA process is one of the main characteristics of this invention. This invention assures that the development process is supervised by QA management via tools. This invention also provides bug report and feedback support, so the development process is more transparent and opener. Rapid prototype iteration model is a good engineering process model. This model can be showed in this platform and be supported by this platform, so this invention is especially suitable for the development of web-based systems.

This invention supports collaborative development and quality evaluation without location constraints. It supports internet-based configuration and control. This invention also closely combines configuration management, project management, quality assurance and collaborative communication tools. The invention builds an environment of collaborative development (including information-changing pushing).

This invention does not regard development process and corresponding processes as separate processes. The invention manages the management and control of software development in two levels: the management in company-level shows the capability of company managing and controlling market, service, resource and coordination in different teams; the management in team level can permit different roles to work according to their authorities assigned, as well communicate with each other. Client is also a role of the invention, thus client can in real time control the project progress and catch the information of quality evaluation. If the system is web-based, the prototype can be run directly and the quality evaluation is made.

This invention uses open development strategy. This platform works with various tools collaboratively. There are no file format constraints in the invention. No matter what formats the files have, they can be stored and managed in this invention.

This invention's configuration management supports the management of unit task and project product. This is very helpful to web-based collaborative development.

As the supplemental part of desktop, this invention's collaborative communication tool integrates many techniques such as BBS, ICQ, Netmeeting, real time message service and file transfer, etc. This tool is also used to have a discussion about the source code for developers and works as the window showing the intelligent search results.

As a collaborative engine, the invention not only provides engineering management, control and collaborative service for web engineering (not only software engineering), but also provides online resource help via resource self-accumulation, intelligent search and pushing. The invention is an intelligent collaborative engine.

The invention combines tools and resources perfectly. It integrates resources, especially human resource, project exchange and collaborative development to provide strong platform support and community service.

Counterparts of This Invention

The counterparts include websites and tools. The desktop tool system environments include PC, LAN and Internet/Intranet. Please refer to the counterparts as follows:

THE WEB-BASED SYSTEM:

http://www.eprojectonline.com/

http://www.eWork.com/

http://www.wproj.com/

http://www.changepoint.com/

http://www.merant-asap.com/ (PVCS Web-based Version)

http://www.itsquare.com

http://www.oneworldsoftware.com/

http://www.inf.com/

http://www.sqa.com/

http://www.sourceforge.com/

http://www.pragmaticsw.com

THE DESKTOP TOOL-BASED SYSTEM:

Qingniao Configuration Management—JBCM/Team

Rational ClearCase

PVCS (Desktop Tool Version)

TeamWave

Groove

Netmeeting

OICQ

Outlook

Project

Sourcesafe

Microsoft@ team manager

Loutus@ SameTime

ANALYSIS AND COMPARISON

Principles of comparison: The main comparison aspect between this invention and desktop tools is function: If we consider function, this invention provides simple but enough functions for users. The invention keeps the kernel and preliminary functions of most desktop tools and guarantees a high integration of various tools. We mainly compare this invention with website platforms. And the comparison aspects include: the integration of tools and the support to development process

A. Web-based systems

www.eprojectonline.com

eProjectonline.com is a free work group. It is mainly used to accomplish collaborative work and knowledge management. This site provides the functions of project management. Users can be classified into two types: project owner and project member. Project owner can create projects, and he/she has the full authority on his/her projects; project members are only the participants of some projects, and they have no rights to modify and delete these projects.

The main functions are provided here:

Trace the hidden bugs in programs;

Manage accidents in development

Trace problems and calls

Customer relationship management

Change management

Project team task list

Help desktop

This site can to some extent help clients in project management, but the function is very simple. In addition, this site does not provide good tools used for real-time communication, control and software quality assurance. This site needs to be refined further. Compared with the disclosed invention, this site only accomplishes some basic functions of the invention.

www.eWork.com

Provider: eWork Exchange, Inc

Product Description: Complete Platform used for web-based project development management

eWork Exchange is the leading global project marketplace on web connecting hiring managers and project professionals. eWork Exchange is a unique market-based exchange where project managers and eworking professionals can connect, engage and work together to complete projects online. Through eWork Exchange, hiring managers and recruiters can find qualified talent and independent professionals can find their ideal projects.

This platform includes:

Two-Side Trade Auto-Matching Engine

Provides payroll, benefits service etc.

Online professional training system

Online Tools, including:

Online Collaboration

Project management

Time tracking & Invoicing

Build a WEB Presence

Product Characteristics:

Abundant online professional training systems

Unique online system demo guide

Combines resource and tools very well, and provides trade-matching engine

Strong project management functions and user-friendly interfaces. The functions cover My Task portal, Project & task management, calendar, contract, file sharing management, discussion board, project report, My to do list etc.

Strong functions of net meeting center. It provides real time communication in multi-media ways. The WebEx Meeting Center makes geography irrelevant. Users can use the Meeting Center to conduct meetings and share virtually any kind of information, in real-time. With WebEx, you can combine telephony with easy-to-use Web conferencing tools. You can also broadcast a video or tour the Web with a colleague.

The system is accomplished by using Java and ShockWave;

No tools are particularly used to support configuration management, quality assurance and bug trace. The tools do not support dual process mechanism and prototype method. Clients cannot actively monitor and control their projects.

Comparison With This Invention

As a tools platform of complete project management solutions, eWork is a very mature and advanced platform. This platform combines resources and tools perfectly. The communication tool is leading. This communication tool has high competence with this invention's communication tool. When considered in project management and real time communication, eWork solutions are stronger than that of the disclosed invention. But the invention shows more importance on quality control and configuration management, because these two processes are very important in software development. These two processes are combined with project management very well in the invention. So the invention strengthens the support to prototype method. This is the invention's strength.

Additionally, eWork provides a service platform for project issuers and developers. Now this site has good reputes and establishes its own brand among project issuers and developers. eWork focuses on C2C business service. If considered in the concept and business service, eWork is one of the strongest competitors of this invention's platform.

WebProject (http://www.wproj.com/)

Provider: Novient

Product Description: Web-based Project Management and Collaboration system

Webproject is a pure Java Project Management Software Tool designed for Internet, intranet and extranet or ASP service. The team will have:

Global Project Management/Access

Full “MS Project” Functionality in a Browser

Document Management

Collaborative Project Discussion Forums (Including desktop chat Tool)

Integrated Executive Information System (EIS)

Cross Platform: Unix, Linux, Windows, Macintosh

Product Characteristics:

Supports multi-platform and thin-client. Clients do not depend on platform (pure Java system). The system infrastructure is three-layer.

Document management is highly integrated with project management.

The entrances and interfaces are set by different roles. The interface style can be customized. The project team can have different portal viewswhich are set up based on access privileges and roles within the organization.

The statistical tool is graphical, and the tool can analyze the cross resource allocations of multi-projects.

Unique collaborative communication forum including two tools and a BBS. The discussed topics can be set and expanded in a tree way.

WebProject is the industry's only product that can be hosted on the Internet without the need for downloads and plug-ins.

Provides rapid search the resources concerned with projects.

The website is combined with various desktop tools.

Document management is very unique. Documents are showed in a directory tree style, and this tool creates hyperlinks of shared resource for corresponding staff to read and use. At the same time, the status of information is marked.

It allows importing project tools results to Webproject via desktop tools. It also allows exchange data between different web servers so system data can be transplanted. You can purchase and install a WebProject Server on your Intranet, so you have complete control over the whole application and your data.

Provides online meeting tool in desktop style

Uses SSL technique to avoid data lose, together with digital signature.

There are arrows to show descending or ascending order. The status of projects is listed graphically.

Resource search engine

There are no constraints to the databases in the back-end

The functions of project management are pragmatic. They allow assigning a task to several developers. This product also has the decision support functions of multi-projects overall information statistical analysis.

Support firewall and proxy mechanism.

No apparent configuration management, quality assurance and control tool. This product does not apparently support dual process mechanism and prototype method.

Comparison With This Invention

WebProject is a good support platform for collaborative software development. In project management and real time communication, it is one of the most capable competitors of this invention. It has optimized infrastructure and user-friendly interfaces. It has no OS constraints. It combines project management and document management via hyperlinks very well. The desktop project management tool can be incorporated into this tool (with offline running support). It can support decision making by completely analyzing project information. But as a platform, WebProject lacks of the setting and allocation of human resource. In the field of supporting the kernel process in development process, it does not as well as this invention does. Furthermore, it supports little to configuration management, quality assurance and bug report and trace. The dual process mechanism and prototype iteration method of this invention determine that this invention can do well in web-based application software development, especially the development of open websites

www.Changepoint.com

Provider: ChangePoint.com

Product Description: It provides full support to the core process in the service supply chain of IT companies. It is the platform which has the widest functions and highest integration. It is an MIS of IT enterprise, but it is not a special web collaborative development platform.

Operate: Automate and streamline critical business processes for greater efficiency

Inter-Operate: Seamlessly integrate and collaborate with staffing suppliers, contractors, clients and partners

The business areas which Changepoint can support:

Marketing

Sales

Engagement Management

Resource Management

Project Management

Time & Expense Capture

Invoicing

Support Management

Knowledge Management

Product Characteristics:

Supports knowledge base management and knowledge search/pushing. Users can subscribe electronic magazine and the system can push the information to users' desktop automatically;

It can be integrated as an interface with Outlook;

This is a system platform with high integration of IT core processes. It covers Internal corporate IT departments, professional services organizations and IT staffing companies, and provides B2B total solutions of service chain;

It can provide different system interfaces based on different roles. Role-based Dashboard Views;

The functions supporting every core process are very good and complete;

Computer Based Training. It is very flexible. Users can customize their favorite computer-based training

Microsoft technique-based□ ASP, SQL Server, IIS, Components;

Supports various client-end ways and offline work;

User-friendly information resource organizing and search;

Strong resource management. This can not only view the workload of developers, but also communicate with them via email and add email confirmation into this function block. This combines resource allocation with the work plan of project members;

It has a high integration of project management and MS project desktop tools. It can also import and export data very freely;

User-friendly and visualized interfaces;

It supports approval and review workflow. It can also personalize workflows, as well as the functions such as event notice and warning based on email;

It provides the programming interface to API, and can integrate the finance system with Changepoint seamlessly;

The finance analysis is very professional;

The development process is open. It allows users to monitor the development and implementation of the whole project;

It supports OLAP and statistical analysis of the dynamic business. It is a decision support system;

It has no configuration management and desktop real time collaborative communication tool, quality assurance tool. It has no apparent support to dual process and does not support prototype iteration process directly.

Comparison With This Invention

If regarded in the aspect of supporting the overall IT process, ChangePoint has very strong advantage. The tools in Changepoint are very good. These tools have close and suitable relationships with each other. It has special advantages in project management, finance management, resource management, and workflow application/check. But ChangePoint has its shortcomings as well. That is: Changepoint depends on MS platform too highly. It lacks of flexible real-time desktop communication tools. Furthermore, it has no web configuration management and quality assurance tools. So although Changepoint has very strong functions, from the view of web collaborative development platform, this invention (Frames) has more advantages than Changepoint has.

www.itsquare.com

Provider: Novient

Product Description: Web-based Project Management and Collaboration system.

Itsquare provides a web-based C2C trade platform for buyers and sellers with the help of unique CDI (Collaborative Development Infrastructure) technology. At the same time, it integrates some functions of project management. Its service focus is to build a trade place for buyers and sellers. It also provides necessary communication service for development process in project management and document management. CDI integrates world-class tools for IT services procurement, project management, and collaboration into a web-based platform enabling enterprises to streamline the entire supply chain. CDI provides a platform to integrate an enterprise's development teams, IT services vendors, implementation partners and customers.

Main Functions:

Determines initial buyer and seller candidates by auto-matching.

Determines final buyer and seller via providing bidding function and online communication tools.

Provides a platform for project development and management

Provides document management function.

System Characteristics:

Integrates part of esoftbank.com eProject and OnTeam

The auto-matching function based on CDI technique is very unique;

It has on-line communication tools, but the tools are limited to communication ways of email. It has no desktop communication tools.

Protects users' private information with the help of safe pages the page with users' private information is submitted in a safe way after encryption.

Provides all protocol templates within trading process, so as to simplify and normalize users' operation.

The style of document management is unique.

It is based on MS ASP technology.

It has an expert help system (knowledge-based), but this system is a separate query system, and it has no intelligent knowledge pushing capabilities.

Comparison With This Invention

This tool is mainly used for the communication and coordination of trade two-sides, and not a professional collaborative tool for project team;

This tool allows sellers to participate development plan and real-time monitor the project progress;

This tool shows more importance to progress, budget and document management. It has no apparent quality and version control methods. It does not support prototype iteration development model;

It has good knowledge query and templates, but the knowledge should be provided in a pushing way.

If regarded as a support platform of collaborative development and software outsourcing, there are some limits in Itsquare. The invention has more advantages in frame than Itsquare.

www.oneworldsoftware.com

Provider: Onewold Software Solutions

Product Description: This is a website which introduces the product family of company, and is not a collaborative development platform.

The product family:

It provides Internet tools, including messaging, voice over IP, Fax over IP etc.

It provides collaborative software, including the web-based enterprise collaborative software;

It provides wireless application software, including WAP, SMS, and Palm OS etc;

It provides enterprise-level software and the corresponding extensional software, including eCRM, Global Portfolio Management & Trading Systems, and Internet-based ERP etc;

Other product development tools;

It provides expert consulting in various technology fields.

This company provides complete software products, and does not provide a software collaborative platform. The invention is a collaborative software development platform.

www.infy.com

Provider: Infosys Technologies Ltd.

Product Description: This is a website which introduces all solutions from Infosys Technologies Ltd. Various information by different categories can also be found here. All the information covers every aspect of software development activities. Here you can find software solutions and their providers. This is a knowledge base of technical support and service, and not an integrated platform which is used for software collaborative development. It includes the following blocks:

Corporate

Solutions

Services

Clients

Investor Relations

Careers

News Room

Contact

Search

Product Characteristics

This site provides detailed company information. Users can get the very picture of Infosys here, such as her research fields, achievements and the corresponding contents;

It provides the detailed solution introductions of Infosys in CRM, e-Business, finance service, insurance, telecom etc. All these solutions can be referred by other software development groups;

It provides the professional service of consulting, engineering (CAD/CAM/CAE), product co-development, system implementation, etc.

Comparison With This Invention

This site and the invention are not in the same category.

This invention provides users with a stronger collaborative software development platform in both resource and tools. This is not Infy's focus.

This invention integrates solutions into the whole software development platform. Users can solve the problems in traditional software development process with the help of the invention. The main focus of Infy is to provide a series of solutions for users to choose. You cannot find the actual solution result from Infy.

This invention is used to collaboratively develop software based on web. Infy is used to search solutions in various fields.

www.sqa.com

Provider: Rational Software Corporation

Product Description: This is a website which in detail introduces the products, service and solutions of Rational Software Corporation. This site also provides the service of downloading beta version and online demo. Developers can easily find the tools they need. These tools are professional CASE tools in the software development process of some fields. These tools can run in PC, LAN and WAN environment. This site does not provide ASP service and integrated web-based collaborative software development tools platform.

The following contents are included:

Partners

Customer Stories

Professional Services

Software Engineering Leadership

Try It Center

Jobs at Rational

Rational Worldwide

Product Characteristics

It provides the support to partners. Users can apply to be the partners of this site and enjoy the latest product update and other service;

It tells the successful stories of Relational's customers. Users can refer to these cases accordingly and search the customer information they need;

It provides professional service. It provides different solutions to customers according to the different phases in software development activities;

It provides the function of downloading beta-version and online demo to help customers know the products further.

Comparison With This Invention

This site and the invention are not in the same category.

The invention provides users with a stronger collaborative software development platform in both resources and tools. This is not SQA's focus.

The invention integrates solutions into the whole software development platform. Users can solve the problems in traditional software development process with the help of the invention. Users can get resource and tools support form the invention's platform. The main focus of SQA is to introduce Rational'sproduct family.

The invention is used to collaboratively develop software based on web. Infy is used to search solutions in various fields and introduce products.

www.sourceforge.com

Provider: VA Linux Systems, Inc.

Product Description: This is a free and open source-oriented collaborative development platform. As an active project in this platform as well, this platform development is openly and continuously developed. It serves for the project team and provides the web-based collaborative development and support of project management, configuration management (CVS), Bug Report, Latest News, mail list, forum, file management and permanent file storage etc.

Product Characteristics

Improves the network security via SSL encryption technique and digital signature;

Integrates project management and document management;

The functions of project management are pragmatic. It allows assigning one task to several persons, and provides statistical analysis of multi-project information;

Document management chooses the style of directory tree on web page;

The setting of collaborative communication forum is based on every project;

Project creator can set the open ability of the project;

There are abundant resources and projects here. Now there are more than 8,000 projects in SourceForge. And the projects cover various fields of application development. There are many reputable software projects here.

Comparison With This Invention

The tools of project management, configuration management and collaboration are very mature, but because this is an open source web site, there is little control to project progress. There is no apparent quality assurance and monitor tool. It does not support dual process mechanism. It is web-based, and does not support desktop tools.

www.pragmaticsw.com

Provider: Pragmatic Software Company

Product Description: It mainly introduces the products of online collaborative development, defect trace and record, desktop tools from Pragmatic Software defect and this company's solution and service. After users' successful registration, they can get the right of use online collaborative development product, defect trace and record product with one-week permission without payment. You can find the demo description here. Users can also freely download the beta-version of desktop tools. If users are satisfied with the products after trial-use, they can buy the products. The information about the solutions of Pragmatic Software Company can also be found here.

The following function blocks are included:

1) Products

Software Planner

Personal Folders

Software Lifecycle

Collaboration

Administration

What's new

Defect Tractor

Track

Shared Documents

Administration

What's new

Desktop Products

Download

Features

2) Purchase

3) Consulting

Customer Solutions

4) Services

5) Earn Cash

6) Contact/About us

7) Link

Product Characteristics

It provides a platform of web-based online collaborative development. This platform can help users make online management, interaction, sharing etc. There is one-week trial-use time for users. If satisfied with the results, users can make their decision to buy the software.

The platform can trace and record the defects, share files.

It provides the detailed description of the desktop tools products' performance. There are beta-versions to download for trial use. If satisfied with the results, users can make their decision to buy the software.

A detailed introduction is made here about the software solutions of Pragmatic Software Company.

Comparison With This Invention

Project management and defect trace report are the strengths of Pragmaticsw. If regarded as a web-based single functional tool, Pragmaticsw has good functions and user-friendly interfaces. But from the view of tools integration, the invention is more advantageous than Pragmaticsw.

From the view of online software development platform, we make the following comparison:

The role assignment in the invention is clearer. There are five different roles in the invention. A person can act only one role or many different roles in a project. The duty in project development is clearer. In project management of Pragmaticsw, project members are only classified as users and security groups.

The invention uses two-level mechanism to manage project: As the professional project management department, Project Management Center is a big resource allocation and management center. You cannot find the same management mechanism from Pragmaticsw.

The project management view of Pragmaticsw is showed in tree-shape. The relationships between levels are very clear. This is very easy to manage. The project management view of the invention is showed in many levels. When users want to see the full view of project management, they have to open the view level by level;

The project management of this invention is more detailed than Pragmaticsw's. The invention can provide the good management of project activity, project close, human resource allocation very well. This can effectively reduce project risk and improve software quality. Compared with the invention, Pragmaticsw does not do as well as the invention does does.

From the view of defect trace and record, Pragmativsw uses tree-shape way to show the results. The invention manages bugs item by item with the help of Bug Report. The invention Bug Report provides stronger search function than Pragmaticsw does.

PVCS Web-based Version

Provider: Merant

Product Description: This is a web-based configuration management tool, together with the function of collaborative communication.

This tool includes the following parts:

Application Management

Customer Login (Portal of various tools)

Issue Management

Version Management and Tracking

Query Management

Interactive tools

Including Chat, Discussion Board, FTP, Mail List. No net meeting function based on panel. The communication is based on text.

The Top of The Workspace

Including Administration help, Support Net and the ASAP community. Additional buttons for Help, Contact us and Logout

Product Characteristics

Unique JAVA Applet interfaces. This system is a pure Java-based system which has no OS platform constraints;

Simple communication tool;

Supports web-based configuration tool, has the functions of difference comparison, component version and single-file version management

Combines version management with bug management

Comparison With This Invention

This is a professional configuration management tool. The function of this tool is almost the same as the requirement of the invention's CVS, but this tool has more user-friendly interfaces and clearer navigation. In change control, the invention has more advantages than PVCS.

The invention is a comprehensive platform with high integration. PVCS cannot compare with the invention on this point. This result is also led by the different business focus of the invention and PVCS. PVCS only provides a part of the invention's functions.

B. DESKTOP-BASED TOOLS

From the objectives of the invention, desktop tools and the invention are not in the same tools category. But they have some relationships with each other, so we make a comparison below.

1. Project Management Tool

Team Manager and Project are two products of Microsoft. These two products are both based on LAN. But they have different focus.

Team Manager emphasizes the management of team, including:

Human Resource Management

Project Control

Project Target Management

Project Manager'scheck

Project emphasizes the management of project progress and time schedule. Users can load the data to Team Manager in Project.

As a platform of web-based collaborative development, project management is the most important part of the invention. The project management of the invention has its unique characteristics:

Supports such activities as making project plan, assigning tasks, accepting tasks, defining task specification on web;

Uses active directory technique and creates a project tree;

The human resource allocation is supported by human resource management system;

Supports dual and parallel process mechanism. Project management and QA management are in parallel. Project management functions are integrated with quality check tools;

In the process of project trace and control, both the progress and quality are checked. As the special member in the project management, customers can view the project progress and the results in real time.

2. Communication Tools

Besides the real time communication tool in the above collaborative development platform, there are also other network communication tools. We will make a comparison between the communication tools in the invention and TeamWave, SameTime from Lotus, Netmeeting from Microsoft, Groove from Groove Networks etc.

TeamWave

TeamWave is an Internet-based communication tool used for virtual team. This tool includes some graphical tools. The mail communication tool is panel. There are no many methods to exchange users' ideas. Users can only dialogue with others in the window via inputting text words. There is little communication of one member to one member. TeamWave does not support audio/video exchange, so this tool is very simple. This tool is suitable to be used in WAN with long distance and heavy load. The server of TeamWave uses central client/server structure, so it is not suitable for a large number of people to communicate with each other online at the same time. When transferring data via panel, it will transfer the full graphical data to server, then the data will be forwarded, so this method brings a great deal of network resource waste. When the data volume is very large, users have to tolerate a very low speed even sometimes users will suffer from server down. Additionally, TeamWave has good transplant ability. It can be run in both windows and UNIX environment. When users use panel, TeamWave pastes images, texts etc via attaching windows. Other tools have no this characteristics. This is a good interface style.

SameTime

SameTime is a member in Lotus OA product family. It is like Netmeeting. The function of its server is very strong. It is one of the good products in real time communication field. SameTime emphasizes visualized communication face to face, so video/audio techniques are widely used in this tool. But Netmeeting needs too much support, Netmeeting is unlike Sametime because Sametime is a one-time solution. That is to say, when users setup Sametime, they only need to setup on server-end, but Netmeeting requires users to install many support softwares. Because Sametime has very flexible client-end and strong server, it is rather good software. The main functions of SameTime includes:

Know

SameTime provides complete function of knowing and having a talk with others. It can help you find other online persons, or create a list of group members and colleagues. It also includes the function of managing users' secrets. Users can control if they show themselves in the network. Users can choose “active”, “offline” and “no bothering”.

Chat

Once you get who is online, you can communicate with him/her easily. So long as you click this user, you can send your message to him/her. You can also start a chat room with many people.

Object Sharing

SameTime has strong capability of object sharing, such as application and panel sharing. Sametime allows you pass your right to other people, and draw the right back anytime. Additionally, Sametime can automatically transfer the common file formats to preloading e-Panel. SameTime also provides a series of note tools which are used to give description based on a topic.

Predefine event

When you are working in office, you can predefine and automatically startup collaborative work. The function of “predefine meeting’ in SameTime can help you start project, meeting according to scheduled plan. All schedules and prepared materials can be stored in SameTime server. Meeting attendees can visit and browse these materials before, after or in the meeting.

Conclusively, SameTime has a very good performance, especially in security, compatibility and transfer support etc. Although SameTime is very strong, a lot of functions are not frequently used by customers. SameTime needs a full-time server. That is why SameTime is not widely used by now.

Comparatively, although Netmeeting is supported by Microsoft greatly, and Netmeeting has nearly similar functions with SameTime, but the performance of Netmeeting is not as good as SameTime's. They both strongly audio/video functions. This is not suitable considering the current heavy-loaded Internet. This is not necessary for engineering development.

Oicq

In fact, Oicq cannot be regarded as a collaborative tool. It is only a communication tool. The function of Oicq is very simple. It is mainly used when online members hope to communicate with each other and chat with other members. Oicq has a user-friendly interface and a very quick transferring speed. Besides the function of chatting based on text, it has also the functions of chatting based on voice chat and file transferring. The functions of OICQ are not very complete because OICQ lacks of the functions of supporting images and sounds.

Groove

This is a real time communication tool for a member or a team. The design of this software is very unique, and it is a good tool among all network collaborative communication tools. It has the following main characteristics:

It works in the peer-to-peer workgroup schema based on non-server. The communication subject creates private workspace in his/her own computer. He/she has to have enough rights to protect his/her own security and not depend on server.

It is based on COM component frame and has open API interfaces;

All data is stored and transferred in XML;

Customizable interfaces and tools box;

Support offline work;

Role-based security management

This tool supports various communication methods including:

instant messaging

live voice

file sharing

pictures

threaded discussion

free-form drawing

outlining

video

OnTeam Collaborative Communication Tool (This Invention)

This tool is a communication tool which integrates electronic panel, real time message service, net meeting discussion, net page, file sharing and transferring. It is a tool used to have a discussion about source code for software collaborative development on web. It is the desktop tools of this invention's website. It is integrated into this invention's website and shares the same database stored in server. It also provides the function of source code edition. Compared with above communication tools, this tool is more focused and pragmatic. It helps developers communicate with each other about code and interface.

3. Configuration Management Tools

1) Microsoft SourceSafe

The unit of check-in and check out is a file. It is closely integrated with Microsoft tools. And the functions are very complex.

2) Peking University Qingniao Configuration Management System—JBCM

Like SourceSafe, this tool includes both server-end and client-end. The information of configuration items is stored in server-end. It uses file-comparison technique, file increment storage. It also presents the conception of component. The unit of check in and check out is a component. It accomplishes version management, but it does not support change control, configuration report, version generation of the whole software system and other configuration management functions.

3) PVCS

It is formed by 7 parts: Version Management, Version Trace, Configuration Creation, Producing Gateway, Report Generation, Development Tool Kit, Announcement. It combines many communication tools.

4) Rational ClearCase

It is embedded some development tools and file systems. It has graphical and user-friendly interfaces. It has separate VOB storage base and does not depend on large database. It can label the specific version and provide simple merge function. This tool is difficult to use. Most functions are not pragmatic. The file merge functions are not very complete. It does not support actual parallel development.

PVCS has web-based and LAN-based versions, and other tools have only a LAN-based version.

TABLE 1
The Main Characteristics of Configuration Management
Tools.

| Tool | This | Microsoft | Qingniao | Rational | PVCS |
|---|---|---|---|---|---|
| Measure | Invention | SourceSafe | JBCM | ClearCase | (Web Version) |
| Configuration | Project, unit | Single file | Component | Single file | File group |
| Items | task and single | | | | |
| | file | | | | |
| has version trace, | Y | Can export any | Support the | Y | Support the |
| exportation of any | | version of files. | version | | version |
| version in product | | Non-support | management of | | management of |
| level and unit task | | the version | file and | | file and |
| level? | | trace of project- | component | | component |
| | | level | | | |
| Supports Internet- | Y | N | Y | N | Y |
| based and unit task | | | | | |
| configuration | | | | | |
| management? | | | | | |
| has authority check | Y | Y | Y | Y | Y |
| when check in and | | | | | |
| check out? | | | | | |
| With a high | Y | N | N | N | N |
| integration with | | | | | |
| project | | | | | |
| management, | | | | | |
| quality assurance | | | | | |
| and collaborative | | | | | |
| communication | | | | | |
| tools? | | | | | |
| With the function | Y | N | N | N | N |
| of change control | | | | | |
| and change | | | | | |
| information | | | | | |
| pushing? | | | | | |
| Can compare and | N | N | N | Y | With comparison, |
| merge files? | | | | | without merging |
| Difference | Y | Y | Y | Separate | NA |
| Storage? | | | | storage base | |
| With high | Y | Y | N | Y | N |
| integration with | | | | | |
| development | | | | | |
| environment? | | | | | |
| (VC++, VB etc) | | | | | |
| Permits QA | Y | N | N | N | Allows to |
| members to check | | | | | download the |
| project results in | | | | | result based on |
| parallel without | | | | | authorities |
| place constraints | | | | | assigned |

What is claimed is:

1. A system comprising at least one collaborative component to eliminate communication barriers between software clients and developers and at least one development component for accelerating software development and enhancing quality assurance.

2. An online software development system comprising three collaborative components to eliminate communication barriers between software clients and developers and three development components for accelerating software development and enhancing quality assurance.

3. A system of claim 1 wherein there are three collaborative components to eliminate communication barriers between software clients and developers.

4. A system of claim 1 wherein there are three interactive development components for accelerating software development and enhancing quality assurance.

5. A system of claim 1 wherein the collaborative components and the development components work in a parallel fashion to smooth the entire software development process.

6. A system of claim 3 in which the three collaborative components comprise: (1) a Quality Assurance Project Manager; (2) Collaboration Management & Project Management; and (3) a Prototype Server.

7. A system of claim 6 wherein communication occurs via the Internet.

8. A system of claim 6 wherein component (1), the Quality Assurance Project Manager, is responsible for four checkpoints.

9. A method of claim 8 wherein the first checkpoint comprises checking the:
a) quality indexes of:
accuracy and reliability of plan definition,
document completeness, and
unity of specification/standard; and
b) items of:
plan of project development and
specifications of doc./standard.

10. A method of claim 8 wherein the second checkpoint comprises checking the:
a) quality indexes of:
accuracy of need definition,
determination of acceptance standard,
completeness of function and data,
understandability of site structure and its software structure,
norm degree of data structure,
guide simplicity,
various exchange methods and easiness (exchangeability), and
access check, data safety and completeness; and
b) items of:
need analysis and specification manual,
specification of system design,
initial acceptance standard,
test plan, and
project progress and fund spending as planned.

11. A method of claim 8 wherein the third checkpoint comprises checking the:
a) quality indexes of:
guide simplicity/page layout,
page visual effect,
various exchange method and easiness (exchangeability),
access check,
data safety and completeness,
robustness,
response time,
program self description (internal notes of program); and
b) items of:
specifications of system design,
specifications of detailed design,
entire effect of prototype, test result and problem databank, and
project progress and fund spending as planned.

12. A method of claim 8 wherein the fourth checkpoint comprises checking the:
a) quality indexes of:
determination/completedness of acceptance standard,
completeness/consistency of document,
indexes related to operating system; and
b) items of:
software configuration,
acceptance standard,
system execution/user training plan, and
project progress/fund spending.

13. A system of claim 6 wherein component (2) (Collaboration Management) comprises multiple management channels, including internal methods among developers (such as a collaborative tool, an intranet-based communication tool and a workflow tool), and external methods between clients and developers (such as a toll-free call center, e-mail, and web conferencing) via a collaboration platform.

14. A system of claim 6 wherein component (2) (Project Management) comprises:
a) Development Plan Management;
b) Resource Management (including human resource, code, documents, solutions, etc.);
c) Expense Management;
d) Development Trace and Control;
e) Configuration Management;
f) Bug Report;
g) Task Management; and
h) Project Member Management.

15. A system of claim 6 wherein component (3) (Prototype Server) comprises an on-site prototype server and an in-house prototype server.

16. A system of claim 1 wherein the three development components comprise: (1) a Development Project Manager; (2) CASE Management & Knowledge Management; and (3) a Development Server.

17. A system of claim 16 wherein software developers communicate with each other via an intranet.

18. A system of claim 16 wherein component (1), the Development Project Manager, is responsible for:
a) leading the development team to make the development plan;
b) submitting stage development results and finishing the whole development of the project (including testing);
c) coordinating with the QA team and clients to revise the development result in order to meet clients' requirements; and
d) assuring software quality required by the QA team.

19. A system of claim 16 wherein component (2), Computer-Aided Software Engineering (CASE) Management, comprises all activities of the whole software survival period, including: personnel organizing and managing, plan management, standardized management, software configuring management, software quality assurance management, spending management, project-tracing, and process controlling management.

20. A system of claim 16 wherein component (2), Knowledge Management, is the core technical support and knowledge-sharing platform.

21. A system of claim 16 wherein component (3), the Development Server, comprises a Collaborative Platform in which Workflow is the tool used to record and monitor all detailed activities of programmers according to different conditions.

22. A system of claim 21 wherein the Collaborative Platform comprises a Configuration Management Server, a Multi-Platform Server, and a Client-Based Database.

23. A system of claim 1 wherein the online software development environment seamlessly connects vendors and buyers of software in terms of dual project managers using dual management tools and dual servers in dual platforms.

24. A system of claim 23 wherein the dual project managers comprise the Development Project Manager and the Quality Assurance Project Manager.

25. A system of claim 23 wherein the dual managements comprise: a) Knowledge Management and Computer-Aided Software Engineering (CASE) & b) Quality Assurance (QA) Management.

26. A method of claim 25 wherein Knowledge Management gives software users access to a full range of services, including, but not limited to, information management, project management, resource center, user management, system maintenance, and technical communication.

27. A method of claim 26 wherein an interface allows third-party software plug in and integrate so as to fully utilize all functions.

28. A method of claim 25 wherein Quality Assurance (QA) Management is handled by the Quality Assurance Manager.

29. A method of claim 23 wherein the dual servers comprise Development Server and Prototype Server, which work concurrently.

30. A method of claim 29 wherein Development Server is used by the project's software programmers and Prototype Server is used by software clients.

31. A method of claim 29 wherein the two servers are independent and linked by Change Management.

32. A method of claim 31 wherein Change Management is delivered through an integrated, project-oriented incident management system.

33. A method of claim 32 wherein each workstation includes its own integrated defect tracking system which links defects to particular pieces of the software code.

34. A method of claim 23 wherein the dual platforms comprise an intranet used by software programmers to access data internally and the Internet used by software clients to access their information.
